(19) United States
(12) Patent Application Publication
(10) Pub. No.: US 2018/0068028 A1
(43) Pub. Date: Mar. 8, 2018

(54) METHODS AND SYSTEMS FOR IDENTIFYING SAME USERS ACROSS MULTIPLE SOCIAL NETWORKS

(71) Applicant: Conduent Business Services, LLC, Dallas, TX (US)

(72) Inventors: VEERASUNDARAVEL THIRUGNANASUNDARAM, Webster, NY (US); Juan Li, Sunnyvale, CA (US); Saurabh Kataria, Rochester, NY (US); Palghat S. Ramesh, Pittsford, NY (US)

(21) Appl. No.: 15/258,315

(22) Filed: Sep. 7, 2016

(51) Int. Cl. G06F 17/30; G06Q 30/02; G06Q 50/00

(52) U.S. Cl. CPC G06F 17/30882; G06F 17/3053; G06Q 50/01; G06F 17/30554; G06Q 30/0201; G06F 17/30867

(57) ABSTRACT

The present disclosure discloses methods and systems for identifying a target profile of a source user on a target social network, based on a corresponding source profile at a source social network. The method includes extracting one or more matching profiles from the target social network, based on one or more static profile features of the source profile, determining one or more dynamic profile features of the source profile and each matching profile, based on real-time user activities on the source and target social networks, and identifying the target profile from the one or more matching profiles, based on a comparison of the one or more dynamic profile features of the source profile with corresponding one or more features of the one or more matching profiles.

### TECHNICAL FIELD

The presently disclosed embodiments are directed to social networks, and more particularly to identifying same users across multiple social networks.

### BACKGROUND

Social media platform is a collective on-line communication channel where users can share information and express opinions. Each social media platform targets different aspects of user's social connections. For example, some social media platforms allow users to post photos, videos and get in touch with friends, while some facilitates business interactions and networking. With time, social media has gained immense popularity as it connects users more closely regardless of their geographic proximity. Examples of social media platforms, include, but are not limited to, Facebook®, Twitter®, Linkedin®, Flickr® and Instagram®, Google Plus®, Pininterest®, hi5®, Tinder® and Trulymadly®.

Social customer relationship marketing is use of social media platforms, techniques and technology to enable organizations to engage with their customers. For instance, many companies study customer's interests and preferences from their on-line posts on various social media platforms, and use it for promotion and campaign reasons.

However, a major challenge in social customer relationship marketing is identifying same customers and listening to those customers across various social media platforms. Identifying same users on various social media platforms is not an easy task for two reasons. First, there is no unique identifier, such as social security number provided on social media to link same users together. Second, many times, users provide only partial information about themselves on social media due to privacy concerns or other reasons.

A conventional technique of identifying same users across multiple social media platforms/networks include using static profile information of a user to identify whether two accounts at two different social media platforms belong to the same user. The static profile information of a user typically contains screen-name, full-name and profile-location of the user. However, the static profile information may not be always available or same or updated across various social media platforms. For instance, a user of name “John Doe” may have a profile at a social media platform, for example, Facebook with some screen name and location. Based on his name, four profiles with the user name “John Doe” may be extracted from another social media platform such as Twitter, but all the four extracted profiles have different screen names and locations. In such cases, it becomes difficult to say whether any of the extracted profiles from Twitter, with the user name “John Doe” is the same user “John Doe” as on Facebook. In other words, it becomes difficult to identify the user of name “John Doe” on another social media platform based on only the static profile information. Further, there are millions of social media accounts in popular social media websites, and it is not practically possible to compare every single profile existing on the social media platforms to identify same users.

It may therefore be advantageous to provide methods and systems for identifying same users across multiple social networks.

### SUMMARY

The present disclosure discloses methods and systems for identifying same users across multiple social networks. In an embodiment, a method for implementing a graphical user interface for identifying a user across multiple social networking websites based on profile, content and network information is disclosed. The method includes creating a list of matching candidates based one or more static features of the user on a social networking website; for the user and each matching candidate, extracting one or more static and dynamic features related to profile, content and social network information; ranking the matched candidates based on the extracted features using a classification model, for identifying the same user on one or more other social networking websites; and presenting within the graphical user interface a way for linking the identified user with the one or more other social networking websites.

In another embodiment, a computer-implemented method for extracting a target profile of a user from an Application Programing Interface (API) of a target social network platform, based on one or more real-time activities of the user on a source and the target social network platform is disclosed. The computer-implemented method includes extracting, by a matching profile extraction module, one or more matching profiles from one or more publically available search APIs of the target social network, based on one or more static profile features of a user profile at the source social network platform; determining, by a feature determination module, one or more dynamic profile features of the user profile and each matching profile, based on one or more real-time activities of the user on the source and target social network platforms, respectively; and identifying, by a target profile identification module, the target profile from the one or more matching profiles, by comparing the one or more dynamic profile features of the user profile with corresponding one or more dynamic profile features of the one or more matching profiles, and processing the comparison results.

In yet another embodiment, a system for extracting a target profile of a user from an Application Programing Interface (API) of a target social network platform based on one or more real-time activities of the user on a source and the target social network platform, is disclosed. The system includes a matching profile extraction module that is configured to extract one or more matching profiles from one or more publically available search APIs of the target social network platform, based on one or more static profile features of a user profile; a feature determination module that is configured to determine one or more dynamic profile features of each of the source profile and the one or more matching profiles based on one or more real-time activities of the user on the source and target social network platforms, respectively; and a target profile identification module configured to identify the target profile from the one or more matching profiles, by comparing the one or more dynamic profile features of the user profile with corresponding one or more dynamic profile features of the one or more matching profiles, and processing the comparison results.

In yet another embodiment, a computer-implemented method for extracting a target profile of a user from an Application Programing Interface (API) of a target social network platform, based on one or more real-time activities of the user, is disclosed. The computer-implemented method includes extracting, by a matching profile extraction module, one or more static profile features of the source profile and extracting, by the matching profile extraction module, one or more matching profiles from one or more publically available search APIs of the target social network platform, based on the one or more static profile features. The computer-implemented method includes determining, by a feature determination module, one or more dynamic profile features of each of the user profile and the one or more matching profiles, based on one or more real-time activities of the user on the source and target social network platforms, respectively; comparing, by a target profile identification module, each dynamic profile feature of each matching profile with corresponding dynamic profile feature of the source profile; and identifying, by the target profile identification module, the target profile from the one or more matching profiles, based on the comparison.

In yet another embodiment, a computer implemented method for identifying a user having a profile on a social media platform, across one or more other social media platforms is disclosed. The computer implemented method includes extracting one or more static features from the profile of the user; extracting one or more matching profiles from one or more publically available search APIs of the one or more other social media platforms based on the one or more static features; extracting one or more dynamic features from the profile of the user and the one or more matching profiles based on corresponding one or more real-time activities of the user; comparing each dynamic profile feature of each matching profile with corresponding dynamic profile feature of the user profile; assigning one or more weightages to the one or more dynamic profile features of each matching profile; ranking the one or more matching profiles based on the comparison and the one or more weightages assigned, and based on the ranking, identifying the user across the one or more other social media platforms.

In yet another embodiment, a computer-implemented method for extracting a target profile of a user from an Application Programing Interface (API) of a target social network platform, based on one or more real-time activities of the user on a source and the target social network platform is disclosed. The computer-implemented method includes extracting, by a matching profile extraction module, a user profile of the user from the source social network; extracting, by the matching profile extraction module, one or more static profile features of the user profile, wherein the one or more static profile features include at least one of: a user name, a screen name, a profile location, an email address, a phone number, a website address, a profile description, and a profile picture; extracting, by the matching profile extraction module, one or more matching profiles from one or more publically available search APIs of the target social network platform, based on the one or more static profile features; and determining, by a feature extraction module, one or more dynamic profile features of the user profile and each matching profile, based on one or more real-time activities of the user on the source and target social networks, respectively. The one or more real-time activities of the user include at least one of: one or more posts, one or more check-ins, one or more uploaded photos, one or more likes, one or more shares, one or more comments, and one or more user connections. Further, the one or more user connections include at least one of: one or more followers, one or more followees, one or more friends, and one or more mutual friends. The one or more dynamic profile features include at least one of: user profile information, user demographics information, user interest pattern, user activity pattern, user's network pattern, and user's geo-tagging pattern. The determining the user interest pattern includes categorizing the user posted content for a pre-defined time period, into one or more pre-defined interest categories. The determining the user activity pattern includes determining one or more timestamps of one or more real-time user activities for the pre-defined time period. Further, the determining the user geo-tagging pattern includes determining a user profile location, one or more user check-in locations, and one or more user content locations, within the pre-defined time period. The method further includes assigning, by a target profile identification module, one or more weightages to the one or more dynamic profile features of the one or more matching profiles; comparing, by the target profile identification module, each dynamic profile feature of each matching profile with corresponding dynamic profile feature of the source profile; ranking, by the target profile identification module, the one or more matching profiles based on the comparison and the one or more weightages assigned; and identifying, by the target profile identification module, the target profile from the one or more matching profiles, based on the ranking.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a block diagram illustrating a system environment in which various disclosed embodiments can be practiced.

FIG. 2 is a block diagram illustrating a system for extracting a target profile of a user from a target social network, based on a source profile of the user on a source social network, in accordance with an embodiment.

FIG. 3 illustrates a matching profile extraction module of the system of FIG. 2, in accordance with an embodiment.

FIG. 4 illustrates a table of various dynamic profile features determined by a feature determination module of FIG. 2, in accordance with an embodiment;

FIG. 5 illustrates comparison of dynamic profile features of the source profile and the matching profiles, in accordance with an embodiment.

FIG. 6 is a flowchart illustrating a method for extracting a target profile of a user from a target social network, based on a source profile of the user on a source social network.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-limiting Definitions

Definitions of one or more terms that will be used in this disclosure are described below without limitations. For a person skilled in the art, it is understood that the definitions are provided just for the sake of clarity, and are intended to include more examples than just provided below:

A “user computing device” may refer to a device that includes a processor/microcontroller and/or any other electronic component, or a device or a system that performs one or more operations according to one or more programming instructions. Examples of the computing device include, but are not limited to, a desktop computer, a laptop, a personal digital assistant (PDA), a mobile phone, a smart-phone, a tablet computer, and the like.

A “social network” may refer to an online platform to build social relations among people who share similar interests, activities, backgrounds or real-life connections. Social networking sites are web-based services that allow individuals to create a public profile, and create a network of friends/users. Social networking sites allow users to share ideas, pictures, posts, real-time activities, events, and interests with people in their network. Examples of the social networks include, but are not limited to: Facebook®, Twitter®, Instagram®, Linkedin® and Flickr®. The “social network” can interchangeably be used with “social media platform”, “social networking websites.” Further, the “social network” may be defined to include any dating website/platform or any similar websites which are typically used for building social relations.

A “user profile” may refer to a program/data store the description of the characteristics of a user. This information can be exploited by systems taking into account the user's characteristics and preferences. A user profile in a social network may store attributes such as a user name, a screen name, a profile location, an email address, a phone number, a website address, a profile description, a profile picture of the user and other details related to the user.

A “static profile feature” may refer to data/details pertaining to a user profile of a social network. The static profile features may be provided by the user and may not be updated automatically until or unless updated by the user. Examples of the static profile feature, include, but are not limited to, a user name, a screen name, a profile location, an email address, a phone number, a website address, a profile description, and a profile picture. The “static profile feature” may be simply be referred to as feature of the profile.

A “dynamic profile feature” may refer to data/details pertaining to a user profile of a social network. The dynamic profile features may be extracted/updated automatically based on user posted content and user network on the social network. Examples of the dynamic profile feature includes, but are not limited to, user profile information, user demographics information, a user-interest pattern, a user activity pattern, a user network pattern, a user geo-tagging pattern, etc.

A “user-post” may refer to a series of words, phrases, sentences, emoticons, images, etc., posted by a user on one or more social networking websites. For example, the user may post one or more messages on their social network for sharing their interests, locations, activities, reviews, opinions, one or more issues, etc.

A “target social network” may refer to a social network that is being searched for extracting a user profile belonging to a user of a given social network.

A ‘target profile’ may refer to a user profile of the target social network.

A “source social network” may refer to a social network at which a given user holds an account.

A “source profile” may refer to a user profile at the source social network.

A “source user” may be a user having a profile on a “source social network” such as Facebook and the “source user” is being searched on the “target social network” such as Twitter, or any other.

A “matching profile extraction module” may refer to a program executing either locally in a user computing device or remotely at a web server for extracting matching profiles from a target social network. The matching profiles may be extracted based on static profile features of a user profile of a given source social network. The “matching profile extraction module” may crawl the matching profiles from the target social network's publically available search APIs. Upon receiving the static profile features as queries, the APIs returns all possible matching profiles as results.

A “feature determination module” may refer to a program executing either locally in a user computing device or remotely at a web server for extracting various dynamic profile features of one or more user profiles of one or more social networks. Example of the dynamic profile features include, but are not limited to, user profile information, user demographics information, a user-interest pattern, a user activity pattern, a user network pattern, and a user geo-tagging pattern.

A “target profile identification module” may refer to a program executing either locally in a user computing device or remotely at a web server for identifying a target profile of the user based on comparison of dynamic profile features of one or more user profiles.

A “user demographic information” may refer to data pertaining to characteristics of a population. Examples of such characteristics include, but are not limited to, race, ethnicity, gender, age, education, profession, occupation, income level, and marital status. The user demographic information of a social network user is determined by analyzing user posted content on the social network

A “user interest pattern” may refer to data pertaining to one or more interests of a social network user over a pre-defined time period. The user interest pattern is determined by categorizing the user posted content into one or more interest categories.

A “user activity pattern” may refer to data pertaining to one or more timestamps of one or more real-time activities of the user in the social network over a pre-defined time period. The “user activity pattern” provides the deep insight regarding when a particular user profile is very active in corresponding social network. For example, an activity pattern of a social network user may be measured by collating timestamps associated with various activities performed by the user, like posting a message, replying to a post, sharing a post, check-ins, and photo uploads, etc. One or more timestamps of one or more user activities may be collated for a pre-defined time duration. A maximum coverage of time duration facilitates accurate prediction of user activity. The time-stamps of activities may be drafted against a time range to predict, when the user is very active on what hour of the day, on what day of the week, on what day of the month, and on what month of the year.

A “user network pattern” may refer to data pertaining to type of user connections in a user's social network over a pre-defined time period. The user connections may include, followees, followers, celebrities, school friends, college friends, family, co-workers and various user communities.

A “user geo-tagging pattern” may refer to data pertaining to one or more locations of a social network user over a pre-defined time period. The “user geo-tagging pattern” is determined based on a user profile location, one or more user check-in locations, and one or more user content locations, and geo-tags added over the pre-defined time period.

The term “linking” refers to soft linking between identified social media profiles in an internal database (although not shown).

For a person skilled in the art, it is understood that the definitions provided above are just for understanding purposes, without limiting the scope of the disclosure.

### Overview

Most of existing approaches of identifying same users across multiple social networks do not pick right features from right sources, for example, picking user location from a user profile of one social network to identify the user in other social networks. In such cases, it may be difficult to identify the user from other social networks, as a user may not input their location in their user profile at other social networks, and/or the profile location may not be updated/same across multiple social networks. In practice, there are millions of social media accounts in popular social media websites, and it is cumbersome to compare every single profile existed on the social media platform to identify the most similar account for a user. In light of these, the present disclosure discloses methods and systems for identifying same users across various social networks.

The disclosure generally relates to methods and systems that link users across various social media platform using effective dynamic profile features obtained from user's profile, user posted content and user's connections and the like. The dynamic profile features are not only obtained from the static profile information of a user, but from various sources such as user posted content and user's connections. The key difference of the present disclosure from existing approaches is how effectively the user profile features are determined and selected for identifying same users across multiple social networks. The dynamic profile features described for identification purposes are more comprehensive as compared to conventional static profile features used for identification of similar users. The effective selection of dynamic profile features reduces the amount of profiles that need to be processed significantly for identification purposes.

### Exemplary Embodiments

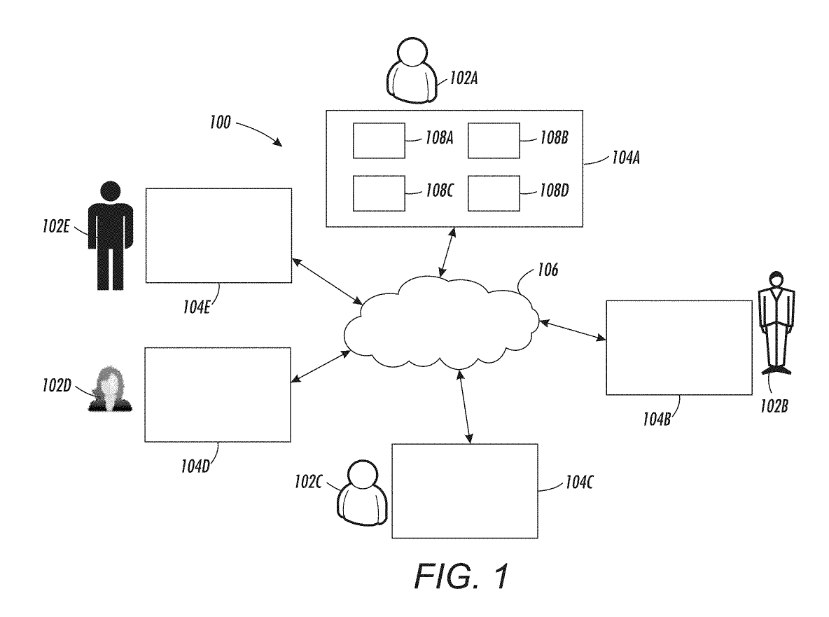

FIG. 1 is a block diagram illustrating a system environment 100 in which various disclosed embodiments can be practiced.

The system environment 100 includes first through fifth users 102a till 102e (hereinafter collectively referred to as users 102) of first through fifth user computing devices 104a-104e (hereinafter collectively referred to as computing devices 104). The user computing devices 104 are communicatively coupled to each other via a communication network 106. Examples of the communication network 106 include wired or wireless network, such as but not limited to, a Local Area Network (LAN), a Wide Area Network (WAN), a Wi-Fi network, and so forth.

The user computing device 104 refers to a computing device used by the user 102 for accessing their accounts in one or more social networking websites, and performing activities like profile creation, posting messages, check-in, and updating pictures on the networking websites. Each user computing device 104 includes a memory (not shown) to store one or more instructions, and a processor (not shown) to provide a browser for executing multiple social networking websites. The user computing device 104 may include a variety of computing devices, such as a personal computer, a laptop, a mobile phone, tablet, PDA, a smart-phone or any other device capable of data communication. It will be apparent to a person skilled in the art that further user computing devices 104 may be added to the system environment 100, without limiting the scope of the disclosure.

In an embodiment, the first user 102a may use the first user computing device 104a to access first through fourth social networks 108a, 108b, 108c and 108d (hereinafter collectively referred to as social networks 108), respectively. Examples of the social networks 108 include, but are not limited to, Facebook®, Twitter®, Instagram®, Linkedin® and Flickr®, Google Plus®, Pininterest®, hi5®, Tinder® and Trulymadly®. In an example, the first user 102a may register with the social networks 108 with different user names and profile locations. While in some embodiments, the first user 102a may be registered with the same user name and/or profile location. It will be apparent to a person skilled in the art that the second through fifth user computing devices 104b-104e may also be used to access social networks 108, without limiting the scope of the disclosure.

In context of the present disclosure, the systems and methods focus on identification of a user on one social network, for example, Facebook® across other social networks such as Twitter®, Instagram® and so on based on real-time activities of the user across one or more social networks.

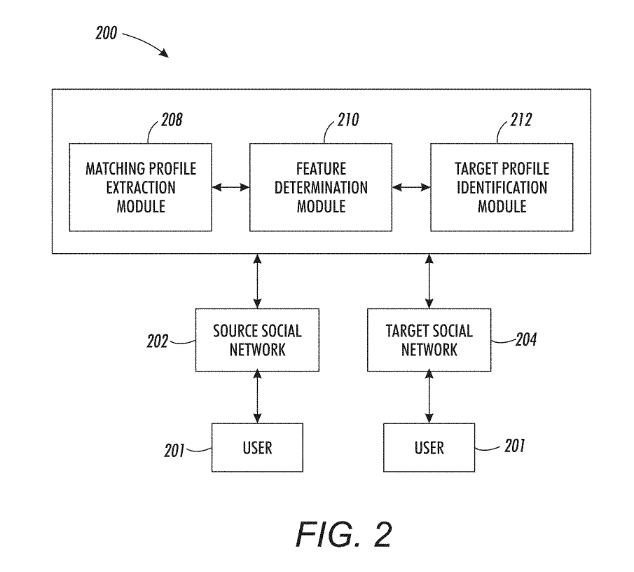

FIG. 2 is a block diagram illustrating a system 200 for extracting a target profile of a user 201 of a source social network 202, from a target social network 204, in accordance with an embodiment.

In an embodiment, the system 200 is a program executing locally in a processor of a user computing device of the user 201. In another embodiment, the system 200 is a program executing remotely at a web server, where a corresponding web/mobile application of the web server executes in a browser of the user computing device.

The system 200 is configured to find a target profile of the user 201 on the target social network 204 based on a source profile of the user at the source social network 202. In an embodiment, the source and target social networks 202 and 204 provide API access to the system 200 to extract their content via online requests. In an example, the source social network 202 is Facebook® and the target social network 204 is Twitter®, and the system 200 is configured to find a matching Twitter® profile of the user 201 based on corresponding Facebook® profile. It will be apparent to a person skilled in the art that the system 200 may also be used to identify multiple target profiles of the user across multiple target social networks, based on a single source profile, without limiting the scope of the disclosure.

The system 200 includes a matching profile extraction module 208, a feature determination module 210, and a target profile identification module 212, for identifying the user 201 of the source social network 202 on the target social network 204.

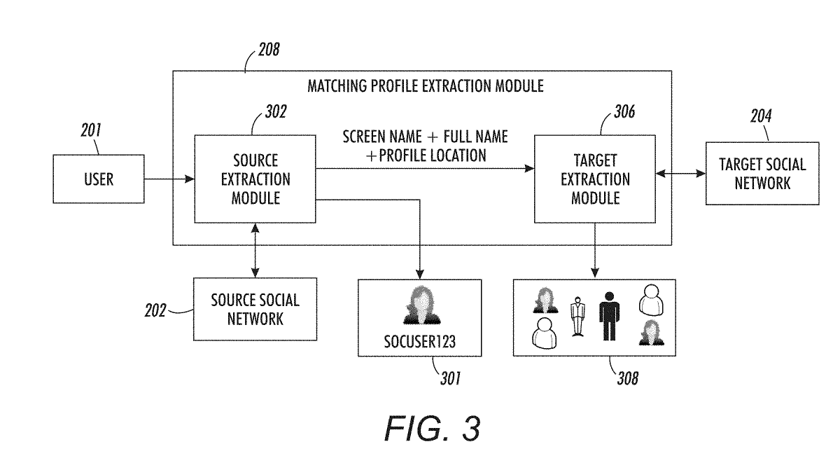

The matching profile extraction module 208 extracts the source profile of the user 201 from the source social network 202 based on a user name of the user 201. Thereafter, it, extracts various static profile features of the source profile, and then extracts various matching profiles from the target social network 204, based on the static profile features. The matching profile extraction module 208 is now explained in detail with reference to FIG. 3.

Referring to FIG. 3, the matching profile extraction module 208 includes a source extraction module 302 that receives a user name/screen name of the user 201, and extracts a source profile 301 of the user 201 from the source social network 202. The source extraction module 302 further extracts various static profile features of the source profile 301. Examples of the static profile features include, but are not limited to, a user name, a screen name, a profile location, an email address, a phone number, a website address, a profile description, and a profile picture of the user 201

The matching profile extraction module 208 further includes a target extraction module 306 that receives the static profile features and uses them to extract various matching profiles 308 from the target social network 204. In an example, the target extraction module 306 uses the static profile features such as screen name, full name and location of the user 201 to extract the matching profiles 308. In an embodiment, the target extraction module 306 uses the static profile features one by one to extract the matching profiles 308. In another embodiment, the target extraction module 306 uses the static profile features in one or more combinations to extract the matching profiles 308. It will be apparent to a person skilled in the art, that the target extraction module 306 may extract the matching profiles 308 based on static profile features other than screen name, full name, and location, without limiting the scope of the disclosure.

In an embodiment, the target extraction module 306 crawls the matching profiles 308 from the target social network's 204 publically available search APIs. Upon receiving the static profile features as queries, the APIs returns all possible matching profiles 308 as results.

In an embodiment, a number of the matching profiles 308 is limited by a matching score, where the matching score describes the similarity between the static profile features of the source profile 301 and a matching profile 308. The matching score is the minimum score that a profile of the target social network 204 must have in order to qualify as one of the matching profiles 308.

In an example, when the source social network 202 is Facebook® and the target social network 204 is Twitter®, then the source extraction module 302 uses a Facebook® screen-name ‘socuser123’ of the user 201 to extract the source profile 301 from Facebook® search API. Upon sending the API call to the Facebook® Search API, the entire profile information of Facebook® user ‘socuser123’ is returned. The source extraction module 302 further extracts various static profile features of the ‘socuser123’ such as ‘screen name’, ‘full name’, profile location, email-address, website-URL, profile-location, an email-address, a website-URL, and a profile description.

The target extraction module 306 uses the static profile features such as screen name, full name and profile location to search the matching profiles 308 in the Twitter® API. The Twitter® API returns a large number of results, however, the target extraction module 306 sets top 100 results as the matching profiles 308. In an embodiment, the target extraction module 306 determines top 100 matching profiles 308 based on the combination weightages of input static profile features. For example, the matching profiles 308 obtained based on a combination of screen name and user name search are given high priority over the matching profiles 308 obtained based on a combination of screen name and location.

Referring back to FIG. 2, the feature determination module 210 extracts various dynamic profile features for the source profile 301 and each matching profile 308 from corresponding social networks based on real-time activities of the user 201 on the source and target social networks 202 and 204, in accordance with an embodiment. The one or more real-time activities of the user 201 include at least one of: one or more user posts, one or more user check-ins, one or more uploaded photos, one or more user likes, one or more shares, one or more user comments, and one or more user connections. In an example, when the source social network is ‘Facebook ’ and the target social network is ‘Twitter®’, the dynamic profile features of the source profile 301 are extracted from ‘Facebook®’, and the dynamic profile features of each matching profile 308 are extracted from Twitter®.

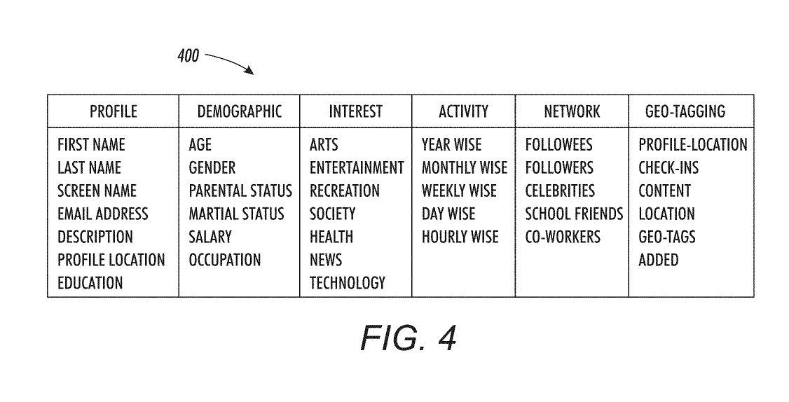

FIG. 4 illustrates a table 400 of various dynamic profile features extracted by the feature determination module 210, in accordance with an embodiment. The dynamic profile features include user profile information, user demographics information, user-interest pattern, user activity pattern, user network pattern, and user geo-tagging pattern. It will be apparent to a person skilled in the art, that the feature determination module 210 may extract dynamic profile features other than the ones illustrated in the table 400, without limiting the scope of the disclosure.

In an embodiment, the feature determination module 210 extracts the dynamic profile features for a user profile by analyzing corresponding user profile information, user posted content, and user's connections such as network of friends. The user profile information includes at least one of: a screen name, a full name, a profile location, an email-address, website-URL, a profile-location, an email address, a website-URL, and a profile description of the user. The user posted content includes at least one of: one or more user posts, one or more user check-ins, one or more uploaded photos, one or more user likes, one or more user shares, and one or more user comments. The user's network of friends includes at least one of: one or more followers, one or more followees, one or more friends, one or more co-workers, one or more celebrities, and one or more school friends of the user.

In an embodiment, the feature determination module 210 extracts the user profile information based on type of source and target social networks. Each social network has their preferences regarding the profile features. Some profile features available in one social network website may not be available in other social network. In an example, Facebook® allows a user to specify an email address in their public profile whereas Twitter® don't expose the email address of the user in their public profile. In a further example, Twitter® has the option to expose the primary device (i.e., mobile, website, API, etc.) used for accessing Twitter®.com, whereas Facebook® does not provide these details in their API results. In a furthermore example, profile features such as education details in Facebook® and LinkedIn® may not be useful while searching for target profiles in Flickr® and Instagram®.

The feature determination module 210 extracts the user demographics information of a user profile based on the corresponding user profile information and user posted content. For each user profile, the feature determination module 210 may analyze textual content of a pre-defined number of posts, such as latest one thousand posts to generate corresponding demographic information.

In an embodiment, the feature determination module 210 uses an existing demographic classifier tool for estimating user demographics information. The demographic classifier may use standard supervised classification technique to estimate the demographics information of a particular user profile. In supervised learning phase, training dataset of historical messages with manually labeled demographic attributes may be provided to the demographic classifier, and corresponding model may learn the features for that dataset. In unsupervised classification process, an existing trained model may be used to classify new results with appropriate demographic labels. The analysis of latest user posts increases prediction accuracy, and data availability for immediate results.

The feature determination module 210 determines the user interest pattern of a user profile by analyzing the textual content of a pre-defined number of latest user posts, for example, one thousand posts. In an embodiment, the feature determination module 210 analyzes the textual content for the presence of specific keywords related to a particular topic of interest of the user. In an embodiment, a pre-defined list of around 40 interest categories may be defined and each interest category may be assigned a dictionary of words representing them. Some examples of the interest categories include Arts, Entertainment, Recreation, Society, Health, News and Technology.

In operation, the pre-defined number of user posts is collected by the feature determination module 210, and each post is then parsed, tokenized and unwanted words may be removed. Then, occurrences of relevant words for each interest category may be counted, and if a post includes a large number of words corresponding to an interest category, the post is assigned that interest category.

The feature determination module 210 determines the user activity pattern by analyzing one or more timestamps of one or more user activities on corresponding social network. The user activity pattern provides the deep insight regarding when a particular user profile is very active in corresponding social network. In an embodiment, for each user profile, textual content of a pre-defined number of latest posts, such as latest five thousand posts may be analyzed to generate corresponding user activity pattern. For example, an activity pattern of a Twitter® user may be measured by collating timestamps associated with various activities performed by the user, like posting a message, replying to a post, sharing a post, check-ins, and photo uploads, etc. In another embodiment, one or more timestamps of one or more user activities may be collated for a pre-defined time duration. A maximum coverage of time duration facilitates accurate prediction of user activity. The time-stamps of activities may be drafted against a time range to predict, when the user is very active on what hour of the day, on what day of the week, on what day of the month, and on what month of the year.

The feature determination module 210 determines the user's network pattern by analyzing the network of user on corresponding social network. The feature determination module 210 analyzes the followees, followers, celebrities, school friends, college friends, family, co-workers and various user communities to generate corresponding user network pattern.

The feature determination module 210 determines the user geo-tagging pattern based on a user profile location, one or more user check-in locations, and one or more user content locations, and geo-tags added over a pre-defined time period. The user profile location is the location that the user post on their social network profiles. The user check-in locations are posted mostly by the user from a mobile client with a GPS installed. The user content locations are locations embedded in user status updates. An existing geo-location extraction module may be used to analyze recent user posts of a pre-defined time period, to get top most locations, from where a particular user has posted messages over the pre-defined time period.

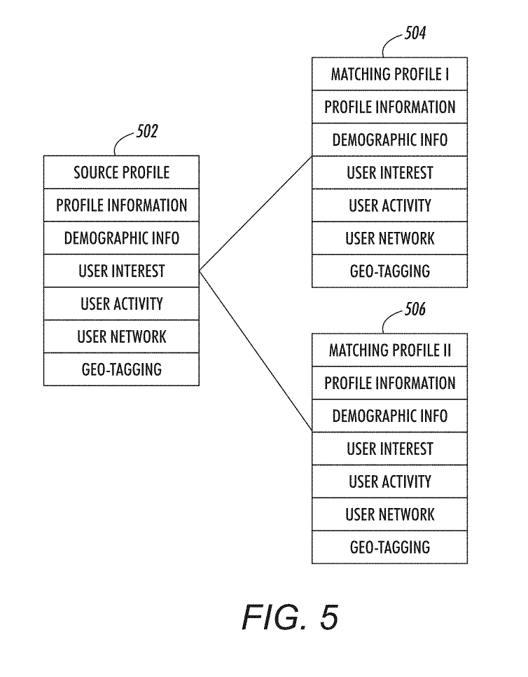

The target profile identification module 212 receives the dynamic profile features of the source profile and each matching profile, and compares each dynamic profile feature of each matching profile (for example, matching profile 308) with corresponding dynamic profile feature of the source profile (for example, profile of the user 201), rank the matching profiles (for example, matching profile 308) based on comparison, and identify the target profile of the source user (for example, the user 201), based on the ranking. The comparison has been now explained in detail with reference to FIG. 5.

FIG. 5 illustrates comparison of dynamic profile features of a source profile 502 with that of the first and second matching profiles 504 and 506, in accordance with an embodiment. In an example, the source profile is of ‘Facebook ’ and the first and second matching profiles 504 and 506 are of ‘Twitter®’.

In an embodiment, target profile identification module 212 may use a classification module to perform the comparison. The classification module may be trained to combine the dynamic profile features together to predict which of the first and second matching profiles 504 and 506 matches with the source profile 502. In an embodiment, the classification module compares each dynamic profile feature of the source profile 502 with that of the first and second matching profiles 504 and 506.

In an embodiment, the classification module may compare each attribute of the profile information of the source profile 502, with corresponding attributes of the profile information of the first and second matching profiles 504 and 506, to determine if the profile information of the source profile 502 matches with the profile information of any of the first and second matching profiles 504 and 506. For example, the profile information of the source profile 502 may include first name as John, last name as Adams, location as New York, the profile information of the first matching profile 504 may include first name as John and location as London, the profile information of the second matching profile 506 may include location as New York and education as graduate. In such case, the first matching profile 504 has a high probability of matching with the source profile 502, over the second matching profile 506.

Similarly, the classification module may compare each attribute of the demographics information of the source profile 502, with corresponding attributes of the demographics information of the first and second matching profiles 504 and 506, to determine if the demographics information of the source profile 502 matches with the demographics information of any of the first and second matching profiles 504 and 506. For example, the demographic information of the source profile 502 may include age as twenty five, gender as female, marital status as unmarried, the demographic information of the first matching profile 504 may include gender as female, marital status as unmarried, and occupation as consultant, the user interest pattern of the second matching profile 506 may include age as twenty seven, and gender as female. In such case, the first matching profile 504 has a high probability of matching with the source profile 502, over the second matching profile 506.

In an embodiment, the classification module may check if one or more categories of the user interest pattern of the source profile 502 are similar to the one or more categories of the user pattern of the first and second matching profiles 504 and 506, respectively. For example, the user interest pattern of the source profile 502 may include categories such as arts, entertainment and politics, the user interest pattern of the first matching profile 504 may include categories such as politics, and movies, and the user interest pattern of the second matching profile 506 may include categories such as entertainment and politics. In such case, the second matching profile 506 has a high probability of matching with the source profile 502, over the first matching profile 504.

In another embodiment, the classification module may compare the user activity pattern of the source profile 502 to determine similar kind of activity pattern of the first and second matching profiles 504 and 506. For example, if a user of the source profile 502 may be active from 12-2 pm daily, a user of the first matching profile 504 may be active from 10-11 pm daily, and a user of the second matching profile 506 may be active from 1-2 pm daily. In such case, the second matching profile 506 has a high probability of matching with the source profile 502, over the first matching profile 504.

In an embodiment, the classification module may use the user's network pattern of the source profile 502 to check similar kind of user friend's network pattern among the first and second matching profiles 504 and 506. For example, if a user of the source profile 502 follows certain celebrities, movie actors, sportsmen or their family members, then it can be checked whether those same people are followed by users of the first and second matching profiles 504 and 506. For example, if the user of the source profile 502 follows Barack Obama in Facebook®, then it can be found whether users corresponding to the first and second matching profiles 504 and 506 follow Barack Obama in Twitter® too.

In yet another embodiment, the classification module may use the location pattern of the source profile 502 to identify the similar location pattern in the first and second matching profiles 504 and 506. If a high number of locations are matched between the source profile 502 and the first matching profile 504, then it may be assumed that the source profile 502 and the first matching profile 504 belong to the same user. For example, if a user of the source profile 502 lives in Webster, N.Y., and the user of the first matching profile 504 posts a lot of geo-tags in his posts, where most of the locations are from Webster, N.Y., a suburb of Rochester. Then, there is a high probability of the first matching profile 504 matching with the source profile 502.

Referring back to FIG. 2, the target profile identification module 212 compute similarity scores for all dynamic profile features between the source profile 502 and each of the first and second matching profiles 504 and 506, based on the comparison. A binary classification model such as logistic regression model may be used to build a model that can predict the probability of matching dynamic profile features from user profiles. A logistic regression model may be defined by:

$$log \frac{prob ( matching )}{1 - prob ( matching )} = {β}_{0} + x β ,$$

where

x the vector of the feature distance, and β is a vector that describes the importance of each feature.

The binary classification model may determine the weight assigned for each feature based on its importance. For example, the model may give higher preference to demographic feature than user interest pattern, or higher preference to name feature over location feature. The target profile identification module 212 may compute all the weightage with preference metrics and return top scored matching profiles. In an embodiment, the returned profiles may be manually analyzed for further processing and usage, and a highest ranked profile may be identified as the target profile.

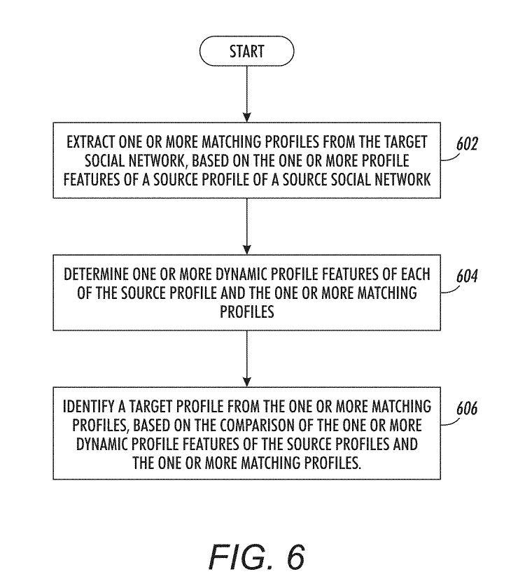

FIG. 6 is a flowchart illustrating a method for identifying a target profile of a source user on a target social network, based on a source profile of the source user on a source social network, and has been explained in conjunction with FIGS. 2 and 3.

At 602, one or more matching profiles 308 are extracted from a target social network 204 based on one or more static profile features of a source profile of a user. Examples of the one or more static profile features include, but are not limited to, a user name, a screen name, a user profile location, an email address, a user phone number, a website address, a profile description, and a user profile picture. In an embodiment, the matching profile extraction module 208 crawls the matching profiles 308 from the target social network's 204 publically available search APIs. Upon receiving the profile features as queries, the APIs returns all possible matching profiles 308 as results.

At 604, one or more dynamic profile features of the source profile 301 and each matching profile 308 are determined by the feature determination module 210 based on real-time activities of the user 201 on the source and target social networks 202 and 204. In an embodiment, the feature determination module 210 extracts the one or more dynamic profile features of a user profile, by analyzing corresponding profile information, posted content, and a network of friends, of the each of the source profile and the one or more matching profiles. Various dynamic profile features include user profile information, user demographics information, a user-interest pattern, a user activity pattern, a user network pattern, and a user geo-tagging pattern.

At 606, a target profile from the one or more matching profiles is identified, based on a comparison of the one or more dynamic profile features of the source profile and the one or more matching profiles. In an embodiment, each dynamic profile feature of each matching profile 308 is compared with corresponding dynamic profile feature of the source profile 301 by the target profile identification module 212. The target profile identification module 212 may use a classification module to perform the comparison. The classification module may be trained to combine the dynamic profile features together to facilitate prediction of the target profile.

In an embodiment, the target profile identification module 212 may compute the weightage of the dynamic profile features with preference metrics and return top scored matching profiles. The target profile identification module 212 may then rank the top scored matching profiles and identify a highest ranked profile as the target profile.

In an embodiment, the target profile(s) may be validated manually by confirming with corresponding user(s). In another embodiment, several evaluation metrics may automatically determine the quality of identified target profile(s).

In an example, the source social network 202 is Facebook® and the target social network 204 is Twitter®, and the system 200 is configured to find a matching Twitter® profile of the user 201 based on corresponding Facebook® profile. A source profile 301 of the user 201 is extracted from Facebook® based on a user screen-name ‘socuser123’, and one or more profile features of the source profile 301 are extracted from Facebook®. The one or more profile features include ‘screen name’, ‘full name’, profile location, email-address, website-URL, profile-location, an email-address, a website-URL, and a profile description. A search may be performed in ‘Twitter®’ with profile features as queries to retrieve one or more matching profiles therefrom.

The search based on the profile features may return a large number of results from Twitter®, however, top 100 results may be set as the matching profiles 308. Then, one or more dynamic profile features of the source profile 301 may be extracted from Facebook® and one or more dynamic profile features of each matching profile 308 may be extracted from Twitter® by analyzing corresponding user profile information, user posted content, and user connections. The one or more dynamic profile features include user profile information, user demographics information, user-interest pattern, user activity pattern, user network pattern, and a user geo-tagging pattern. Thereafter, each dynamic profile feature of the source profile 301 is compared with corresponding dynamic profile feature of each matching profile 308, one or more weightages are assigned to the one or more dynamic profile features, and the target ‘Twitter’ profile is identified based on the ranking and the comparison.

Once identified, the user/profile associated with the source social media platform (i.e., Facebook®), is linked with the target social media platform (i.e., Twitter®) by the system. This is performed via a graphical user interface.

In some embodiments, the system can be integrated with any social networking website, facilitating identification of the same user across social networking websites. Further, the system can be implemented by a third party service provider, for identifying same users across those multiple social networking sites that provide user's data publically through data APIs or graphical user interfaces. Examples of such social networking sites, include, but are not limited to, Twitter, and Instagram.

For a person skilled in the art, it is understood that disclosure explicitly outlines few examples of the social medial platforms, features (dynamic, and/or static), etc., for understanding purposes. However, the disclosure can be implemented for all existing social media platforms or platforms developed later.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “generating,” or “monitoring,” or “displaying,” or “tracking,” or “identifying,” “or receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for implementing a graphical user interface for identifying a user across multiple social networking websites based on profile, content and network information, comprising:
creating a list of matching candidates based one or more static features of the user on a social networking website;
for the user and each matching candidate, extracting one or more static and dynamic features related to profile, content and social network information;
ranking the matched candidates based on the extracted features using a classification model, for identifying the same user on one or more other social networking websites; and
presenting within a graphical user interface a way for linking the identified user with the one or more other social networking websites.

2. The method of claim 1, wherein the one or more static and dynamic features include at least one of: profile information, demographic information, interests, temporal activity pattern, spatial activity pattern and social network data.

3. The method of claim 1, further comprising extracting the one or more static features of the user.

4. The method of claim 1, further comprising performing search based on the one or more static features to identify the list of matching candidates.

5. A computer-implemented method for extracting a target profile of a user from an application programing interface (API) of a target social network platform, based on one or more real-time activities of the user on a source and the target social network platforms, the computer-implemented method comprising:
extracting, by a matching profile extraction module, one or more matching profiles from one or more publically available search APIs of the target social network platform, based on one or more static profile features of a user profile at the source social network platform;
determining, by a feature determination module, one or more dynamic profile features of the user profile and each matching profile, based on one or more real-time activities of the user on the source and target social network platforms, respectively; and
identifying, by a target profile identification module, the target profile from the one or more matching profiles, by comparing the one or more dynamic profile features of the user profile with corresponding one or more dynamic profile features of the one or more matching profiles, and processing the comparison results.

6. The computer-implemented method as claimed in claim 5, wherein the one or more static profile features include at least one of: a user name, a screen name, a profile location, an email address, a phone number, a website address, a profile description, and a profile picture.

7. The computer-implemented method as claimed in claim 5, wherein the one or more real-time activities of the user include at least one of: one or more user posts, one or more user check-ins, one or more uploaded photos, one or more user likes, one or more shares, one or more user comments, and one or more user connections.

8. The computer-implemented method as claimed in claim 7, wherein the one or more user connections include at least one of: one or more followers, one or more followees, one or more celebrities, one or more school friends, one or more friends, and one or more co-workers.

9. The computer-implemented method as claimed in claim 5, wherein the one or more dynamic profile features include at least one of: user profile information, user demographics information, user interest pattern, user activity pattern, user's network pattern, and user geo-tagging pattern.

10. The computer-implemented method as claimed in claim 9, wherein the user demographics information includes at least one of: an age, a gender, a parental status, a marital status, a salary, and an occupation.

11. The computer-implemented method as claimed in claim 9, wherein the determining the user interest pattern includes categorizing user posted content for a pre-defined time period, into one or more pre-defined interest categories.

12. The computer-implemented method as claimed in claim 9, wherein the determining the user activity pattern includes determining one or more timestamps of one or more real-time user activities for a pre-defined time period.

13. The computer-implemented method as claimed in claim 9, wherein the determining the user geo-tagging pattern includes determining a user profile location, one or more user check-in locations, and one or more user content locations, for a pre-defined time period.

14. The computer-implemented method as claimed in claim 5, wherein the identifying the target profile further comprises:
comparing each dynamic profile feature of each matching profile with corresponding dynamic profile feature of the source profile;
assigning one or more weightages to the one or more dynamic profile features of each matching profile; and
ranking, by the target profile identification module, the one or more matching profiles based on the comparison and the one or more weightages assigned.

15. A system for extracting a target profile of a user from an application programing interface (API) of a target social network platform, based on one or more real-time activities of the user on a source and the target social network platform, the system comprising:
a matching profile extraction module configured to extract one or more matching profiles from one or more publically available search APIs of the target social network platform, based on one or more static profile features of a user profile at the source social network platform;
a feature determination module configured to determine one or more dynamic profile features of the user profile and each matching profile based on one or more real-time activities of the user on the source and target social network platforms, respectively; and
a target profile identification module configured to identify the target profile from the one or more matching profiles, by comparing the one or more dynamic profile features of the user profile with corresponding one or more dynamic profile features of the one or more matching profiles, and processing the comparison results.

16. The system as claimed in claim 15, wherein the one or more static profile features include at least one of: a user name, a screen name, a profile location, an email address, a phone number, a website address, a profile description, and a profile picture.

17. The system as claimed in claim 15, wherein the one or more real-time activities of the user include at least one of: one or more user posts, one or more user check-ins, one or more uploaded photos, one or more user likes, one or more shares, one or more user comments, and one or more user connections.

18. The system as claimed in claim 17, wherein the one or more user connections include at least one of: one or more followers, one or more followees, one or more celebrities, one or more school friends, one or more friends, and one or more co-workers.

19. The system as claimed in claim 15, wherein the one or more dynamic profile features include at least one of: user profile information, user demographics information, user interest pattern, user activity pattern, user's network pattern, and user geo-tagging pattern.

20. The system as claimed in claim 19, wherein the user demographics information includes at least one of: an age, a gender, a parental status, a marital status, a salary, and an occupation.

21. The system as claimed in claim 19, wherein the determining the user interest pattern includes categorizing user posted content for a pre-defined time period, into one or more pre-defined interest categories,
wherein the determining the user activity pattern includes determining one or more timestamps of one or more real-time user activities for the pre-defined time period, and
wherein the determining the user geo-tagging pattern includes determining a user profile location, one or more user check-in locations, and one or more user content locations, for the pre-defined time period.

22. The system as claimed in claim 21, wherein the target profile identification module is further configured to:
compare each dynamic profile feature of each matching profile with corresponding dynamic profile feature of the user profile;
assign one or more weightages to the one or more dynamic profile features of each matching profile; and
rank the one or more matching profiles based on the one or more weightages assigned and the comparison.

23. A computer-implemented method for extracting a target profile of a user from an application programing interface (API) of a target social network platform, based on one or more real-time activities of the user on a source and the target social network platform, the computer-implemented method comprising:
extracting, by a matching profile extraction module, one or more static profile features of a user profile at the source social network platform;
extracting, by the matching profile extraction module, one or more matching profiles from one or more publically available search APIs of the target social network platform, based on the one or more static profile features;
determining, by a feature determination module, one or more dynamic profile features of the user profile and each matching profile, based on one or more real-time activities of the user on the source and target social network platforms, respectively;
comparing, by a target profile identification module, each dynamic profile feature of each matching profile with corresponding dynamic profile feature of the user profile; and
identifying, by the target profile identification module, the target profile from the one or more matching profiles, based on the comparison.

24. The computer-implemented method as claimed in claim 23, wherein the one or more real-time activities of the user include at least one of: one or more user posts, one or more user check-ins, one or more uploaded photos, one or more user likes, one or more shares, one or more user comments, and one or more user connections.

25. The computer-implemented method as claimed in claim 23, wherein the one or more dynamic profile features include at least one of: user profile information, user demographics information, user interest pattern, user activity pattern, user's network pattern, and user geo-tagging pattern.

26. The computer-implemented method as claimed in claim 25, wherein the determining the user interest pattern includes categorizing the user posted content for a pre-defined time period, into one or more pre-defined interest categories, and wherein the determining the user activity pattern includes determining one or more timestamps of one or more real-time user activities for the pre-defined time period, and wherein the user geo-tagging pattern includes determining a user profile location, one or more user check-in locations, and one or more user content locations for the pre-defined time period.

27. A computer implemented method for identifying a user having a profile on a social media platform, the identification of the user is performed across one or more other social media platforms, comprising:
extracting one or more static features from the profile of the user;
based on the one or more static features, extracting one or more matching profiles from one or more publically available search APIs of the one or more other social media platforms;
extracting one or more dynamic features from the profile of the user and the one or more matching profiles based on corresponding one or more real-time activities of the user;
comparing each dynamic profile feature of each matching profile with corresponding dynamic profile feature of the user profile;
assigning one or more weightages to the one or more dynamic profile features of each matching profile;
ranking the one or more matching profiles based on the comparison and the one or more weightages assigned; and
based on the ranking, identifying the user across the one or more other social media platforms.

28. The computer implemented method as claimed in claim 27, further comprising: linking the user across the one or more other social media platforms.

29. A computer-implemented method for extracting a target profile of a user from an application programing interface (API) of a target social network platform, based on one or more real-time activities of the user on a source and the target social network platforms, the computer-implemented method comprising:
extracting, by a matching profile extraction module, a user profile of the user from the source social network;
extracting, by the matching profile extraction module, one or more static profile features of the user profile, wherein the one or more static profile features include at least one of: a user name, a screen name, a profile location, an email address, a phone number, a website address, a profile description, and a profile picture;
extracting, by the matching profile extraction module, one or more matching profiles from one or more publically available search APIs of the target social network platform, based on the one or more static profile features;
determining, by a feature extraction module, one or more dynamic profile features of the user profile and each matching profile, based on one or more real-time activities of the user on the source and target social networks, respectively,
wherein the one or more real-time activities of the user include at least one of: one or more posts, one or more check-ins, one or more uploaded photos, one or more likes, one or more shares, one or more comments, and one or more user connections,
wherein the one or more user connections include at least one of: one or more followers, one or more followees, one or more friends, and one or more mutual friends,
wherein the one or more dynamic profile features include at least one of: user profile information, user demographics information, user interest pattern, user activity pattern, user's network pattern, and user's geo-tagging pattern,
wherein the determining the user interest pattern includes categorizing the user posted content for a pre-defined time period, into one or more pre-defined interest categories,
wherein the determining the user activity pattern includes determining one or more timestamps of one or more real-time user activities for the pre-defined time period, and
wherein the determining the user geo-tagging pattern includes determining a user profile location, one or more user check-in locations, and one or more user content locations, within the pre-defined time period;
assigning, by a target profile identification module, one or more weightages to the one or more dynamic profile features of the one or more matching profiles;
comparing, by the target profile identification module, each dynamic profile feature of each matching profile with corresponding dynamic profile feature of the source profile;
ranking, by the target profile identification module, the one or more matching profiles based on the comparison and the one or more weightages assigned; and
identifying, by the target profile identification module, the target profile from the one or more matching profiles, based on the ranking.
